(19) United States
(12) Patent Application Publication
(10) Pub. No.: US 2004/0197450 A1
(43) Pub. Date: Oct. 7, 2004

(54) High pressure homogenizing method

(75) Inventor: Catherine Schorsch, Boulogne Billancourt (FR)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Compagnie Gervais Danone

(21) Appl. No.: 10/412,452

(22) Filed: Apr. 11, 2003

(30) Foreign Application Priority Data
Apr. 4, 2003 (FR) 0304203

(51) Int. Cl. A01J 1/00

(52) U.S. Cl. 426/519

(57) ABSTRACT

The invention provides a method of manufacturing a dessert or a fermented product, the method including a step of homogenizing a milk-based emulsion at high pressure, wherein the homogenizing pressure P is greater than 400 bars and less than 2000 bars, wherein the total quantity of fats in the emulsion lies in the range 2% to 10% by weight, and wherein the total quantity of proteins lies in the range 2% to 5% by weight.

The present invention relates to a method of homogenizing a dessert or a fermented product, the method including a step of homogenizing a milk-based emulsion at high pressure.

### BACKGROUND OF THE INVENTION

In the prior art, fermented products such as liquid yogurts or desserts such as ice creams have been made by subjecting them during manufacture homogenizing at high pressures lying in the range 100 bars to 250 bars.

The technique of homogenizing is very old. It was begun in 1890 by Gaulin and was originally intended for homogenizing milk. It consists in causing a coarse emulsion to flow under pressure through a narrow space in order to reduce the size of the fat globules in the milk, thereby increasing the lifetime of the product by retarding segmentation phenomena.

High pressure homogenizing is different from pascalizing which consists in subjecting a substance to static high pressure for a relatively long period of time (more than a few minutes).

### OBJECTS AND SUMMARY OF THE INVENTION

The present invention seeks to provide a homogenizing method presenting improved performance, in particular concerning the texture of the end product.

The invention thus provides a method of manufacturing a dessert or a fermented product, the method including a step of homogenizing a milk-based emulsion at high pressure, wherein the homogenizing pressure P is greater than 400 bars and less than 2000 bars, wherein the total quantity of fats in the emulsion lies in the range 2% to 10% by weight (which fats come essentially from the milk and the added milk powder), and wherein the total quantity of proteins lies in the range 2% to 5% by weight, and more particularly in the range 4% to 5% by weight.

The method of the invention leads to a significant improvement in texture (viscosity) and to improved stability for given formulation. For equivalent texture and organoleptic qualities, it serves in particular to enable protein content to be reduced compared with a conventional homogenizing method. For equivalent texture and organoleptic qualities, it also serves to enable fat content to be reduced compared with a conventional method, in particular in desserts.

The pressure may be greater than 500 bars and less than 1000 bars, and in particular it may be less than 800 bars.

The pressure may be greater than 800 bars and less than 1000 bars.

The total quantity of fats may lie in the range 2% to 6% by weight, and more particularly in the range 2% to 4%.

The total quantity of fats may lie in the range 3.5% to 3.6% by weight, for example, with the total quantity of proteins then lying in the range 4.2% to 4.6% by weight.

In a variant, while temperature is rising, the method may comprise:

preheating the emulsion to a first temperature T1;

performing said homogenizing operation, during which the emulsion is raised to an output temperature T2>T1;

allowing to stand at a temperature substantially equal to T2; and

pre-cooling to a temperature T3<T1.

Preferably the temperature T1 and the pressure P are selected so that T2=95° C.

In another variant, while temperature is falling, the method may comprise:

preheating the emulsion to a standing temperature T;

allowing to stand at said temperature T;

pre-cooling to a temperature T′<T; and

performing said homogenizing operation.

### BRIEF DESCRIPTION OF THE DRAWINGS

Other characteristics and advantages of the invention appear on reading the following description given with reference to the drawings, in which:

FIG. 1 shows a preferred implementation of the invention, taking place during temperature rise;

FIG. 2 is a graph plotting curves of particle diameter distribution for a formulation of the fat-containing yogurt type, before homogenizing, after homogenizing at 200 bars (prior art), and after homogenizing at 1800 bars, with FIG. 3 plotting curves of initial viscosity as a function of shear for the above-mentioned homogenizing operations performed at 200 bars and at 1800 bars; and

FIGS. 4 to 8 are graphs plotting curves of initial viscosity as a function of shear for various formulations and at different pressures.

### MORE DETAILED DESCRIPTION

All tests were performed while temperature was rising, except the test at 200 bars specifically shown in FIG. 6 which was performed while temperature was falling.

During the manufacture of yogurts (thick or stirred), a mixture of cream and of milk enriched with proteins (e.g. by adding skimmed milk powder) is subjected to heat treatment comprising homogenizing prior to fermentation.

Conventional homogenizing consists in causing the milk mixture, whether fatty or otherwise, to pass through a valve at a pressure of about 150 bars to 250 bars.

The homogenizing step transforms the initial coarse milk emulsion into a finer emulsion of fats in water (fat globule diameter lying mainly in the range 0.4 micrometers (μm) to 1 μm). The performance of this step is related both to the equipment and to the operating conditions. Wetting molecules (mainly milk proteins and emulsifiers) are needed in order to stabilize the new water/oil interfaces that are created.

The purpose of this homogenizing step is to create fat globules of smaller size, and thus avoid possible creaming of the fat during the subsequent fermenting step. Homogenizing, which refines fat globules into smaller droplets, increases the interface area considerably. While fermentation is taking place during the manufacture of yogurts, the droplets become incorporated in the resulting lattice, thus giving a firmer texture and a gel that is more stable.

Surprisingly, the Applicant company has found that it is possible to obtain a significant improvement in texture by subjecting the mixture (emulsion) to a homogenizing operation at a pressure that is considerably higher than the pressures presently in use. This improvement in texture is obtained for pressures P greater than about 400 bars, in a range of pressures extending from 400 bars to 2000 bars.

The most advantageous pressure range is from 500 bars to 1000 bars.

Good results are obtained in the range 500 bars to 800 bars, with better results being obtained in the range 800 bars to 1000 bars, and the optimum pressure is about 850 bars.

An improvement is still obtained by raising the pressure to values greater than 1000 bars, but the net result is small and implementing such pressures gives rise to problems of industrial implementation.

The applicant company has also observed that a first increase in viscosity is obtained by homogenizing while temperature is falling rather than while temperature is rising.

While being homogenized, the substance is forced under pressure P through a valve between the valve member and the valve seat. The globules are broken up by the following effects in succession: striking the valve member; throttling (shear) between the valve member and the valve seat; and elongating as the milk relaxes, with the sudden drop in pressure also leading to globules bursting. In addition, there is a heating effect (temperature difference observed between the outlet and the inlet of the homogenizing unit) which becomes significant from 400 bars and which is of the order of 2° C. to 2.5° C. for a pressure increase of 100 bars. This temperature increase is thus about 11° C. for a pressure of 800 bars and 15° C. for a pressure of 1000 bars.

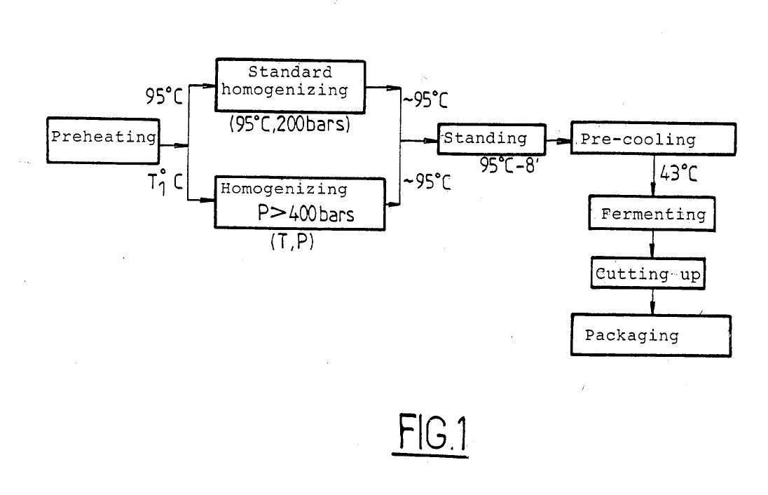

FIG. 1 is a flow chart relating to an example of manufacturing yogurt with homogenizing being performed while temperature is rising (i.e. after preheating and prior to allowing to stand). The initial emulsion is preheated to a temperature which is 95° C. for standard homogenizing at 200 bars (high branch relating to a conventional method). For homogenizing in accordance with the invention (low branch) at a pressure P greater than 400 bars, preheating is performed to a temperature T1 below 95° C., which temperature is selected as described below so that the temperature T2 after homogenizing is 95° C. As a result, the heating which takes place during homogenizing is used to raise the emulsion to its standing temperature. Thereafter, the homogenized mixture is allowed to stand at 95° C. for 8 minutes (pasteurizing), and it is then pre-cooled at a temperature T3 equal to 43° C. and subjected to fermentation (at 39° C.), followed by cutting up (“décaillage”) prior to being packaged in pots.

It is also possible to homogenize while temperature is falling, i.e. after standing and before pre-cooling.

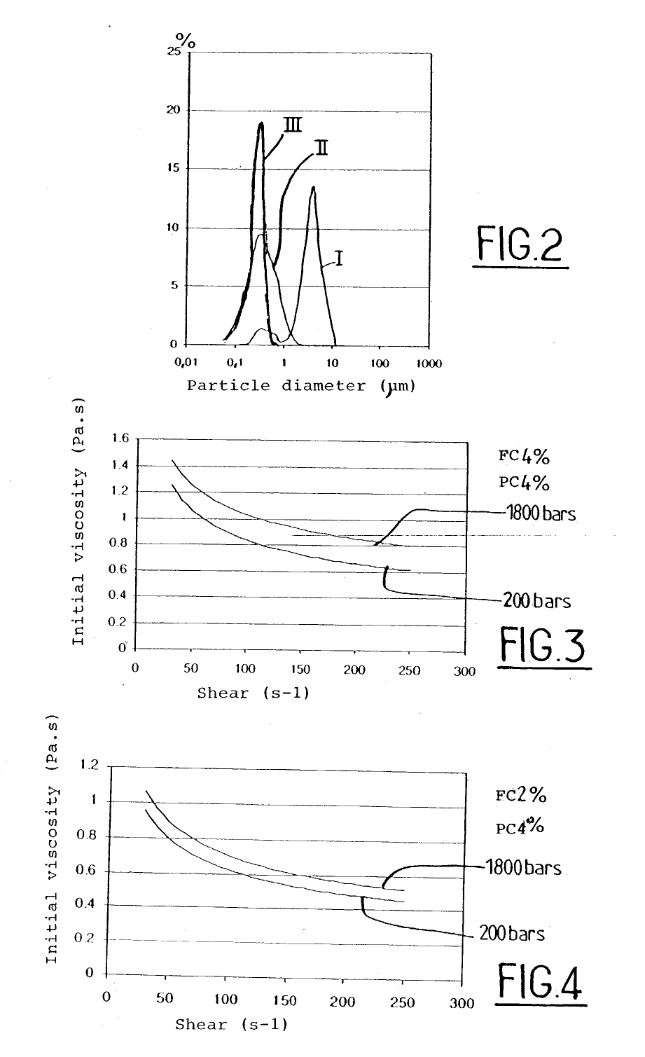

For a formulation having 4% by weight of fats and 4% by weight of proteins (“fat” yogurt), curves showing the distribution of the sizes of fat globules are obtained as shown in FIG. 2, in which curve I is prior to homogenizing, curve II is after homogenizing in accordance with the prior art at 200 bars, and curve III is after homogenizing at 1800 bars, and curves of initial viscosity as a function of shear are given in FIG. 3 for the two above-specified homogenizing pressures.

Prior to homogenizing (curve I), two populations are clearly distinct with a median diameter substantially equal to 3.46 μm.

After homogenizing (curves II and III), the distribution has become monomodal (a single peak), and the casein micelles (about 0.2 μm to 0.3 μm) coincide with the fat globules. The effect of pressure can be seen firstly on the mean diameter of the particles which goes from 0.4 μm at 200 bars (curve II) to 0.27 μm at 1800 bars (curve II). Secondly, with pressure of 200 bars, 90% of the total volume of fat is occupied by particles smaller than 0.72 μm, as compared with 0.42 μm for homogenizing at 1800 bars. The resulting distribution is thus much narrower at 1800 bars than at 200 bars, as can be seen by comparing curves II and III.

Homogenizing under the above-specified conditions makes it possible with all formulations to produce emulsions that are finer because of the reduction in the mean size of the fat globules, and to obtain a narrower distribution with a significant reduction in larger globules (practically no fat globules of a size greater than 1 μm in the above example), as compared with conventional homogenizing (in which a significant quantity of globules remain of a size greater than 1 μm). This point is of great importance since even though reducing the mean size of the particles is a desirable aim, it is even more important to reduce the quantity of large particles of fat in the distribution of particle sizes, because they are the particles that contribute to instability phenomena in the product over time.

In addition, it is found that the fermenting and gelling rate of the substance is unchanged, which shows that the homogenizing pressure does not have any effect on its reaction rate and viscoelastic structure.

Gelling is caused by the casein lattice, by proteins aggregating.

FIG. 3 plots curves of initial viscosity in Pascal seconds (Pa.s) as a function of shear in per second units (s⁻¹), for homogenizing pressures of 200 bars and of 1800 bars for the emulsion in FIG. 2. The measurement was performed at the outlet from a cooler before smoothing.

As can be seen from the curves in FIG. 3, the difference in viscosity is constant whatever the shear speed and is equal to about 0.2 Pa.s, which corresponds to an increase in viscosity (a “texture improvement”) of about 20% compared with conventional type homogenizing (200 bars).

FIG. 5 plots curves of viscosity under the conditions of FIG. 3, the protein content being 4% and 5% respectively for a homogenizing pressure of 1800 bars. The increase in viscosity under such circumstances is then about 0.3 Pa.s, giving a texture improvement of about 25%. With 5% protein, even greater positive differences can thus be obtained relative to those obtained in the preceding example for a fat yogurt formulation (fat content FC 4% and protein content PC 4%).

Under all circumstances, these significantly greater viscosity levels are conserved as manufacture continues, since the loss of viscosity between the outlet of the cooler and prior to the product being packaged (destructuring), lies in the range 25% to 30% regardless of the homogenizing pressure applied (in the range 200 bars to 1800 bars).

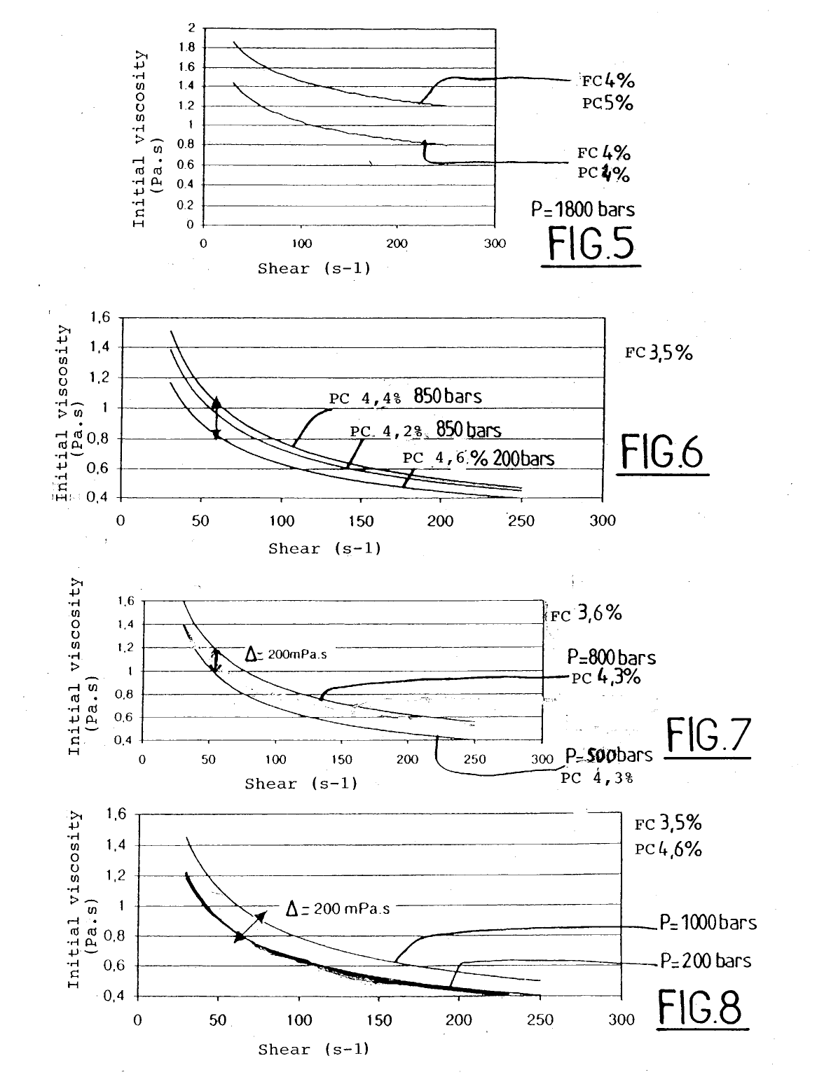

For a lean yogurt type composition (total fat content FC equal to 2% and total protein content PC equal to 4%), the difference in viscosity between homogenizing at 200 bars and at 1800 bars is about 0.6 Pa.s to 0.1 Pa.s. This is shown in the viscosity curves of FIG. 4 for a composition by weight comprising 2% fat content FC and 4% protein content PC. Changing the protein content from 4% to 5% does not significantly alter these observations with this level of fat content.

As with a fat yogurt type composition, destructuring is practically independent of homogenizing pressure.

The measurements performed thus lead to two important observations:

for given homogenizing pressure P, the relative increase in viscosity increases with increasing fat content, and also with increasing protein content. The first point is illustrated in particular by the viscosity curves of FIG. 4. The second point is illustrated more particularly in FIG. 5 which relates to the initial viscosity values of two fat yogurt formulations (FC 4% and PC equal to 4% or 5%, respectively) with a homogenizing pressure of 1800 bars.

The effect of pressure on particle size dispersion for the fat globules occurs essentially in the range 500 bars to 1000 bars. It can be estimated that the phenomenon begins at around 400 bars.

A test performed at a homogenizing pressure of 850 bars on a formulation having 3.5% fat content FC and 4.2% protein content PC shows that in terms of texture parameters, microstructure parameters, and organoleptic parameters, this homogenizing pressure (as compared with a standard pressure of 200 bars) compensates for a reduction in protein content of 0.4 percentage points (protein content PC going from 4.6% to 4.2%).

At constant fat content, it is possible with homogenizing pressure P>500 bars, to obtain a product of viscosity comparable to a product homogenized in conventional manner (e.g. at 200 bars), but with a reduction in the protein content PC (i.e. in practice, for a yogurt formulation, with a reduction in the quantity of added skimmed milk powder), thus achieving a saving in raw materials for given organoleptic qualities.

By way of example, the method of the invention makes it possible by increasing the homogenizing pressure to reduce the quantity of proteins by about 10% (thus achieving considerable savings) for a product whose organoleptic quality is substantially identical or better than that of prior art products, with this being achieved starting with homogenizing pressures of 500 bars, viscosity increasing with homogenizing pressure, as can be seen in particular from FIG. 6.

FIG. 6 plots curves of initial viscosity as a function of shear for three formulations all having a fat content FC of 3.5%, and having three different protein contents PC respectively equal to 4.6% (whole milk 85.2%, cream 1.3%, sugar 7.3%, powdered skimmed milk 6.2%) with homogenizing at 200 bars, PC equal to 4.2% with homogenizing at 850 bars, and PC equal to 4.4% with homogenizing at 850 bars, homogenizing being performed while temperature was rising at 850 bars and while temperature was falling at 200 bars.

In spite of the reduction in the protein content PC, there can be observed an average increase A in viscosity which is of the order of 0.1 Pa.s, which, in organoleptic terms, corresponds to a significant improvement. It should also be noted that the increase in viscosity is observed despite a first improvement due to choosing to homogenize while temperature is falling for the test at 200 bars.

Going up to 850 bars gives rise to a significant reduction in the mean size, and the size distribution of fat globules is considerably narrowed, whereas going from a pressure of 200 bars to 400 bars has more effect on the size distribution of fat globules than on mean size. Above 1000 bars, any increase in viscosity is minor, and the same applies to the advantage obtained in terms of the size of fat globules, and more particularly concerning the presence of fat globules of large size (1 μm or more), but industrial implementation becomes more difficult at such pressures.

As a result, the most advantageous pressure range is 500 bars to 1000 bars.

The effect of raising pressure from 500 bars to 800 bars is illustrated by FIG. 7 for a formulation having a fat content FC of 3.6% by weight. The curves of viscosity as a function of shear correspond to P=500 bars and 800 bars for PC=4.3%.

For pressures of 500 bars and 800 bars, viscosity remains high in spite of the reduction in protein content PC from 4.5% to 4.3%. For a pressure of 800 bars, the mean increase A of viscosity is about 0.2 Pa.s relative to the value obtained when homogenizing at 500 bars.

Finally, FIG. 8 shows the influence of pressure (200 bars and 1000 bars) on a formulation having a fat content FC of 3.5% and a protein content PC of 4.6%. A mean difference A of 0.2 Pa.s can be observed for a pressure of 1000 bars.

The curves thus show that the range of pressure values P that is the most advantageous is 500 bars to 1000 bars, and preferably 800 bars to 1000 bars, with the most preferred pressures being about 800 bars to 850 bars.

For given formulation and at these pressure levels, and in particular at pressures in the range 800 bars to 1000 bars, an increase in viscosity of about 0.2 Pa.s is achieved compared with homogenizing performed in conventional manner, and this leads to a significant improvement in organoleptic terms. Still at these pressure levels, reducing the total protein content PC by approximately 5% to 10% (0.2 to 0.4 percentage points for a protein content PC of about 4.4%), thereby significantly decreasing the quantity of powdered skimmed milk that needs to be added to a yogurt type formulation (by up to 25%), still enables a product to be obtained whose organoleptic qualities (as tested by a panel) and whose retention of characteristics over time are substantially similar to those of products homogenized in conventional manner, but using a formulation that is richer in proteins.

Additional increases in viscosity could be obtained by implementing high-pressure homogenizing while temperature is falling.

However, in order to simplify the method, homogenizing while temperature is rising may be preferred.

The examples given correspond to viscosities measured the day D0 of manufacture of the finished emulsions. The differences in texture observed between the emulsions of the invention and the reference emulsions are maintained or increase over time during the life time of the emulsion. The strength of gel measured by penetrometry also confirm this difference in texture during the life time of the emulsion.

The present invention thus makes it possible to control or optimize the texture and the stability of a dessert, or of a fermented product, e.g. liquid yogurt, with homogenizing in accordance with the invention also being capable of achieving a fine and stable distribution of bubbles of air when the product is a mousse.

What is claimed is:

1/ A method of manufacturing a dessert or a fermented product, the method including a step of homogenizing a milk-based emulsion at high pressure, wherein the homogenizing pressure P is greater than 400 bars and less than 2000 bars, wherein the total quantity of fats in the emulsion lies in the range 2% to 10% by weight, and wherein the total quantity of proteins lies in the range 2% to 5% by weight, and in particular in the range 4% to 5% by weight.

2/ A method according to claim 1, wherein said pressure is greater than 500 bars and less than 1000 bars.

3/ A method according to claim 2, wherein said pressure is greater than 500 bars and less than 800 bars.

4/ A method according to claim 2, wherein said pressure is greater than 800 bars and less than 1000 bars.

5/ A method according to claim 1, wherein the fat content lies in the range 2% to 6% by weight, and more particularly in the range 2% to 4%.

6/ A method according to claim 4, wherein the fat content is substantially equal to 4% by weight.

7/ A method according to claim 4, wherein the fat content lies in the range 3.5% to 3.6%, and wherein the protein content lies in the range 4.2% to 4.6%.

8/ A method according to claim 1, comprising:
preheating the emulsion to a first temperature T1;
performing said homogenizing operation, during which the emulsion is raised to an output temperature T2>T1;
allowing to stand at a temperature substantially equal to T2; and
pre-cooling to a temperature T3<T1.

9/ A method according to claim 8, wherein the temperature T1 and the pressure P are selected so that T2=95° C.

10/ A method according to claim 1, comprising:
preheating the emulsion to a standing temperature T;
allowing to stand at said temperature T;
pre-cooling to a temperature T′<T; and
performing said homogenizing operation.
